(19) United States
(12) Patent Application Publication
(10) Pub. No.: US 2006/0174216 A1
(43) Pub. Date: Aug. 3, 2006

(54) Providing additional hierarchical information for an object displayed in a tree view in a hierarchical relationship with other objects

(76) Inventors: Trenten Peterson, Morgan Hill, CA (US); Erik Bruce Underkofler, Austin, TX (US); Ningning Wang, Round Rock, TX (US)

Correspondence Address: KONRAD RAYNES & VICTOR, LLP, 315 S. BEVERLY DRIVE, # 210, BEVERLY HILLS, CA, 90212, US

(21) Appl. No.: 11/046,431

(22) Filed: Jan. 28, 2005

(51) Int. Cl. G06F 17/00; G06F 17/24; G06F 3/00

(52) U.S. Cl. 715/853; 715/854; 715/509

(57) ABSTRACT

Provided are a method, system and program for providing additional hierarchical information for an object displayed in a tree view in a hierarchical relationship with other objects. A representation of the hierarchical arrangement of the objects is displayed. Selection is received of one object in the displayed hierarchical arrangement and a determination is made as to whether a table is associated with the selected object. The table associated with the selected object is displayed in response to determining that the table is associated with the selected object.

### BACKGROUND OF THE INVENTION

1. Field of the Invention

The present invention relates to providing additional hierarchical information for an object displayed in a tree view as in a hierarchical relationship with other objects.

2. Description of the Related Art

A computer user may display in a graphical user interface (GUI), such as a file browser program or web browser, a tree view of objects, such as files, programs, folders, attributes, etc., in a hierarchical relationship, such as files in a hierarchical file system. The tree view may display folders representing groupings of objects at different hierarchical levels. Tree type GUIs may use different levels of indentation to present the hierarchical relationship of the elements. Viewing such tree views can become difficult as the number of child and sub-child elements and attributes of one element increases.

Another way to present information, such as attributes, about objects and elements in a GUI is to use a table where the properties/attributes of an object are presented in columns of the table.

### SUMMARY

Provided are a method, system and program for providing additional hierarchical information for an object displayed in a tree view in a hierarchical relationship with other objects. A representation of the hierarchical arrangement of the objects is displayed. Selection is received of one object in the displayed hierarchical arrangement and a determination is made as to whether a table is associated with the selected object. The table associated with the selected object is displayed in response to determining that the table is associated with the selected object.

### BRIEF DESCRIPTION OF THE DRAWINGS

FIG. 1 illustrates an embodiment of a computing environment.

FIG. 2 illustrates an embodiment of object information.

FIG. 3 illustrates an embodiment of a tree view page showing a hierarchical representation of objects.

FIG. 4 illustrates an embodiment of a tree view page where the child elements of parent entries are removed or collapsed.

FIG. 5 illustrates an embodiment of a tree view page where the user selected to add a child entry to a selected entry.

FIG. 6 illustrates an embodiment of a tree view page where the user selected to remove an entry.

FIG. 7 illustrates an embodiment of a tree view page where the user selected to edit the content of an entry.

FIG. 8 illustrates an embodiment of operations to display a tree view of objects.

FIG. 9 illustrates an embodiment of operations to process a selection of a selectable control for one entry.

FIG. 10 illustrates an embodiment of operations to process a selection of a selectable control for an entry whose child entries are displayed.

FIG. 11 illustrates an embodiment of operations to process user selection to add an entry to the displayed table.

FIG. 12 illustrates an embodiment of operations to delete or modify an entry in the displayed table.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

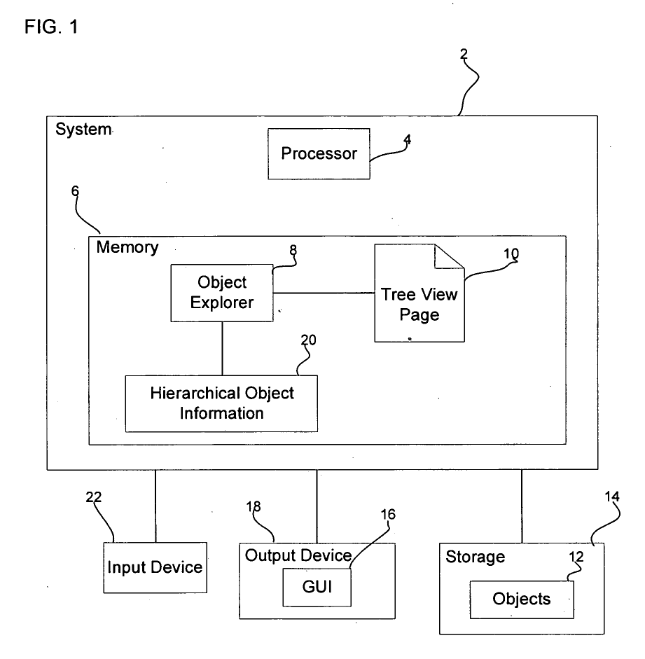

FIG. 1 illustrates a computing environment comprising a computer system 2 having a processor 4 and memory 6. The processor 4 executes an object explorer 8, such as a file explorer, browser or other type of GUI rendering program, that generates a tree view page 10 providing a hierarchical tree view of objects 12 in a storage device 14. The tree view page 10 may be presented in a graphical user interface (GUI) 16 rendered on an output device 18 coupled to the system 2, such as a monitor. The object explorer 8 processes hierarchical object information 20 on the objects 14 and their hierarchical relationship to generate the tree view page 10. The tree view page 10 may comprise a structured document, such as a document encoded in Hypertext Markup Language (HTML), Extended Markup Language (XML), etc., or other page formats.

The system 2 is coupled to an input device 22, such as a mouse, pen-pointer, touch sensitive display screen, keyboard, voice activated input, etc., that enables a user to provide input to the system, such as input to traverse and select objects represented in the tree view page 10 presented in the GUI 16. The output device 18 coupled to the system 2 may comprise a computer monitor. The storage 14 coupled to the system 2 may comprise an internal or external storage device, e.g., hard disk drive, electronic memory, tape, optical storage, etc., directly coupled to the system 2 or comprise storage the system 2 communicates with over a network. The memory 6 may comprise a volatile memory device. Objects 12 may be loaded into the memory 6 when they are selected by a user of the system 2 in the tree view page 10 in the GUI 16 using the input device 22. The objects 12 may comprise files, programs, cataloged items, structured documents (e.g., Extensible Markup Language (XML) files), attributes, classifications, records, a folder grouping other objects or folders or other data structures.

The hierarchical object information 20 may include groupings of objects, such as folders, that organize the objects 12 at different hierarchical levels, such as folders that organize files at different hierarchical levels in a hierarchical file system.

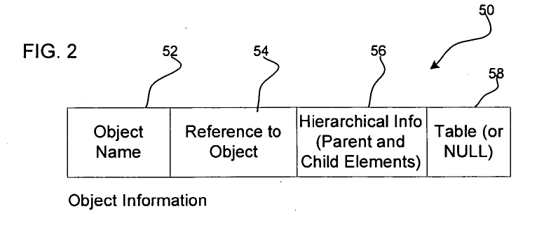

FIG. 2 illustrates an example of object information 50 included in the hierarchical object information 20 for each object capable of being represented in the hierarchical tree view. The object information 50 includes: an object name 52; a reference to the object 54 in the storage 14, such as a pointer, storage location, etc.; hierarchical information 56 on the hierarchical location of the object with respect to other objects, such as child and parent information for the object placing the object in the hierarchy; and a table field 58 identifying a table associated with the object or NULL indicating that no table is associated with the object. The table field 58 may include the table data structure or a reference or pointer to the table.

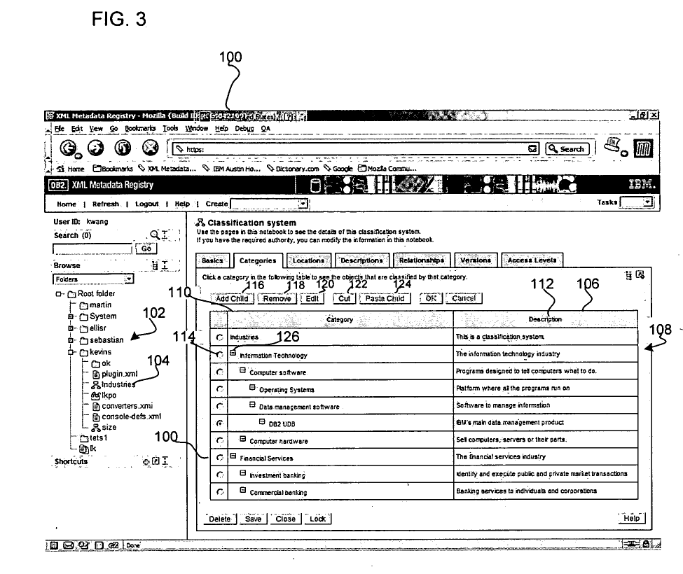

FIG. 3 illustrates an example of a tree view page 100 showing a hierarchical representation of objects in panel 102 rendered by the object explorer 8. Selection of industries object 104 causes the display of table 106 associated with the industries object 104 providing information on the industries object 104, such as information on different industries, a broad industry definition, e.g., information technology, financial services, etc., and then sub-industry categories shown as child nodes of the broader industry definitions, such as computer software, computer hardware, investment banking, commercial banking, etc. Additional information for each of the types of industry is provided and shown as child entries of the industry entries including further specific industry information. In this way information and further subcategories of that information on a selected object 104 are displayed in the table 106 in a hierarchical manner.

Each entry, e.g., 108, in the table 106 includes a category column 110 providing a name of the attribute and a description column 112 providing a description of the entry. In further embodiments, there may be additional or different columns with different information. Each entry, e.g., 108, includes a selectable control, such as a radio button 114 to enable selection of the entry 108. The page 100 also displays additional selectable controls, such as an “add child” button 116 to allow a user to add an entry to the table as a child to an entry whose selectable control, e.g., radio button, is selected when the “add child” button 116 is selected; a “remove” button 118 to remove the entry whose selectable control, e.g., radio button, is selected when the “remove” button 118 is selected; and “edit” button 120 to enable editing of the entry whose selectable control, e.g., radio button, is selected when the “edit” button 120 is selected. Other buttons, such as 122, may allow cutting and removing an entry whose selectable control, e.g., radio button, is selected when the “cut” button 122 is selected. The “cut” or removed entry may then be pasted as a child to the entry whose selectable control, e.g., radio button, is selected when the “paste as child” button is selected 124.

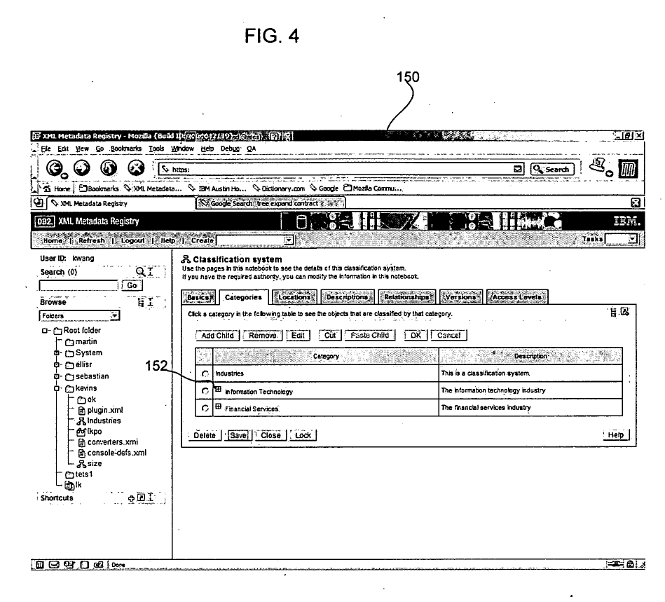

FIG. 4 illustrates an example of the tree view page 150 where the child elements of parent entries “Information Technology” and “Financial Services” are removed or collapsed by pressing the “minus” controls, e.g., 126, in FIG. 3. The child entries could be displayed by pressing the “plus” controls, e.g., 152, in FIG. 4.

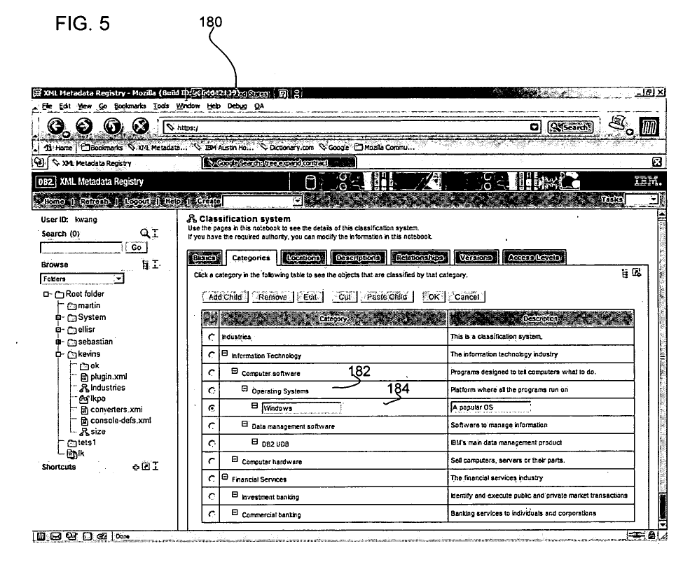

FIG. 5 illustrates an example of a tree view page 180 where the user selected to “add child” with the “operating system” entry 182 selected to cause the entry 184 to be added so the user may then add the category name and description in the columns.

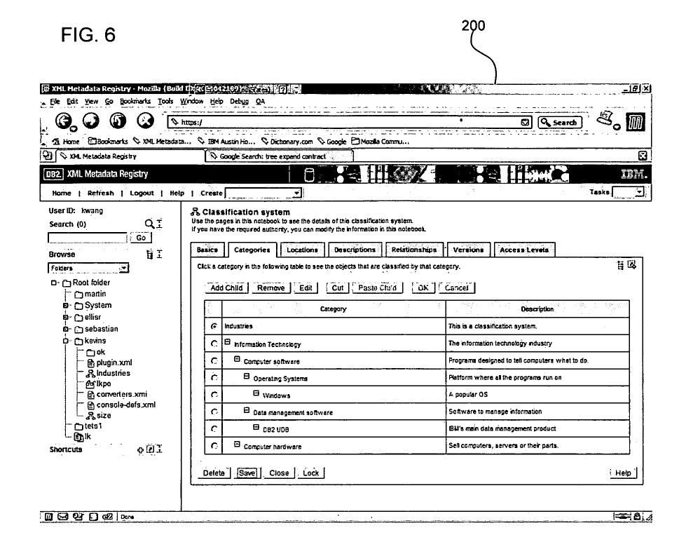

FIG. 6 illustrates an example of a tree view page 200 where the user selected to remove the financial services entry 130, shown in FIG. 3, along with all child entries to the removed financial services entry 130 by selecting the remove button 118 with the financial services entry 130 radio button selected (FIG. 3).

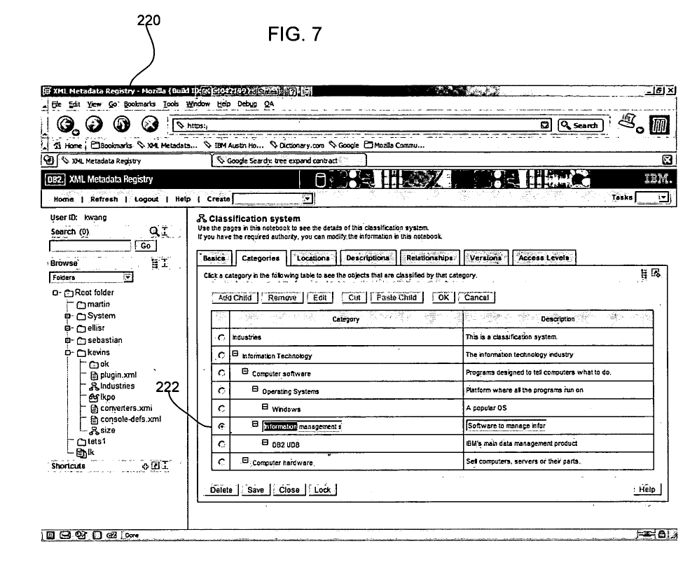

FIG. 7 illustrates an example of a tree view page 220 where the user selected to edit the content in the columns for the information management entry 222 by selecting the edit button 120 shown in FIG. 3.

FIGS. 8-12 illustrate operations performed by the object explorer 8 to render the tree view pages 100, 150, 180, 200, 220 and respond to user actions with respect to the rendered table. In response to initiating (at block 300) an operation to display a GUI tree view 10 of objects 12, the object explorer 8 processes (at block 302) information indicating a hierarchical arrangement of objects, e.g., 20, and associating at least one object with a table including entries, where the entries in the table provide information on the object associated with the table. The information may be in the format of the object information 50 shown in FIG. 2 providing hierarchical arrangement information for objects and indication of whether a table is provided for a particular object represented in the hierarchy. A representation of the hierarchical arrangement of the objects indicated in the information, e.g., 20, is then displayed (at block 304), such as the hierarchical view of elements in panel 102 in FIG. 3. Upon receiving (at block 306) user selection of one object in the displayed hierarchical arrangement, e.g., object 104 in FIG. 3, a determination is made (at block 308) as to whether the object information 50 for the selected object indicate that one table is associated with the selected object, e.g., a table is indicated in field 58. If (at block 308) a table is not provided for the selected object, then the selected object, e.g., 104, is displayed (at block 310) as selected without table information. Otherwise, if a table is provided, then the table associated with the selected object is displayed (at block 312), such as the table 110 shown in FIG. 3 and the other figures. The object explorer 8 may further display (at block 314) in the entries a first column having a category descriptor and a second column having a description of the category descriptor, such as shown in FIGS. 3-7. Further displayed (at block 316) are selectable controls, e.g., radio button 114, with the entries in the displayed table 110 to enable selection of one entry by selection of the displayed radio button.

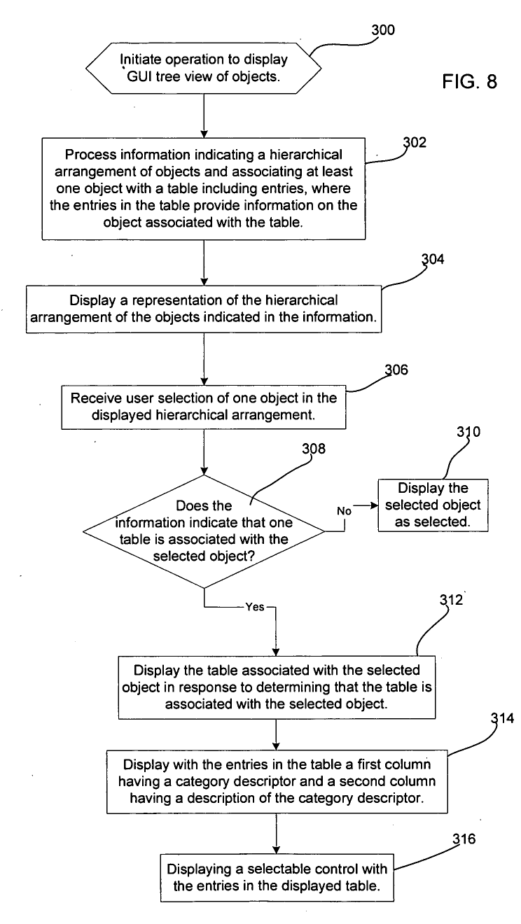

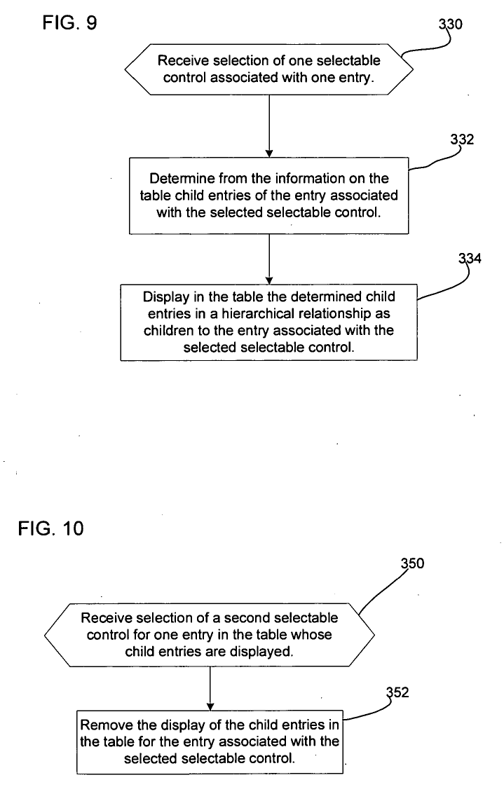

FIG. 9 illustrates operations performed by the object explorer 8 to process a request to display child entries in the table, e.g., 110. Upon receiving (at block 330) selection of one selectable control associated with one entry, such as the “plus” control 152 shown in FIG. 4, the object explorer 8 determines (at block 332) from the information 52 on the table child entries of the entry associated with the selected selectable control. The determined child entries are displayed (at block 334) in the table, e.g., 110, in a hierarchical relationship as children to the entry associated with the selected selectable control.

FIG. 10 illustrates operations performed by the object explorer 8 to process a request to remove child entries in the table, e.g., 110. Upon receiving (at block 350) selection of a remove selectable control, e.g., remove button 118 (FIG. 3) for one selected entry in the table whose child entries are displayed, the object explorer 8 removes (at block 352) the display of the child entries in the table for the entry associated with the selected selectable control. As discussed, FIG. 6 illustrates the results of removing the financial services entry and all its children from the displayed table.

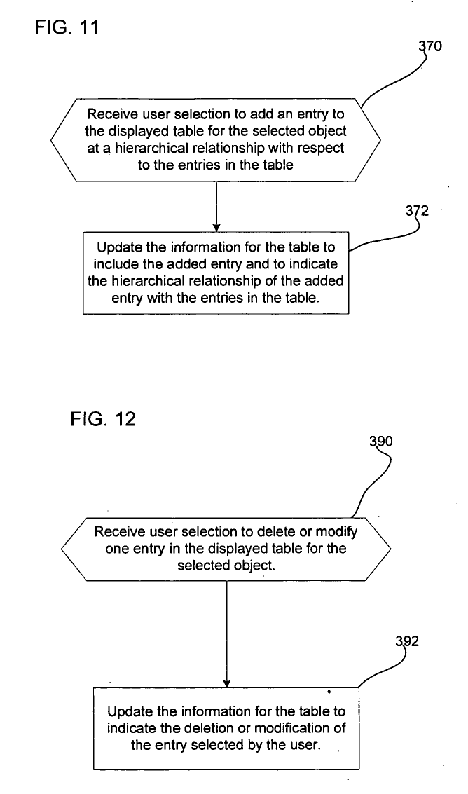

FIG. 11 illustrates operations performed by the object explorer 8 to process a request to add an entry to the table, e.g., 110. Upon receiving (at block 370) a user selection to add an entry to the displayed table for the selected object at a hierarchical relationship with respect to the entries in the table, the object explorer 8 updates (at block 372) the information for the table to include the added entry and to indicate the hierarchical relationship of the added entry with the entries in the table. FIG. 7 illustrates an example of adding an entry 222 to be a child of the “Computer Software” entry.

FIG. 12 illustrates operations performed by the object explorer 8 to process a request to delete or modify an entry to the table, e.g., 110. Upon receiving (at block 390) user selection to delete or modify one entry in the displayed table for the selected object, the object explorer 8 updates (at block 392) the information for the table to indicate the deletion or modification of the entry selected by the user.

In described embodiments, a table associated with an object rendered in a hierarchical view may be displayed with the object, where the table provides additional information on the object, such that the entries in the table may be organized in a hierarchical relationship to reflect the hierarchical nature of the information provided by the entries. Described embodiments further provide techniques to add, delete, modify, change the view, etc., of the entries in the table.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The illustrated operations of FIGS. 8, 9, 10, 11, and 12 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
displaying a representation of a hierarchical arrangement of a plurality of objects;
receiving selection of one object in the displayed hierarchical arrangement;
determining whether a table is associated with the selected object; and
displaying the table associated with the selected object.

2. The method of claim 1, further comprising:
displaying, in the table, entries arranged in an entry hierarchical relationship to provide information on the object associated with the table.

3. The method of claim 2, further comprising:
displaying selectable controls associated with the entries in the displayed table;
receiving selection of one selectable control associated with one entry; and
displaying at least one child entry for the entry associated with the selected selectable control.

4. The method of claim 3, wherein displaying the at least one child entry comprises displaying child entries as hierarchical children to the entry associated with the selected selectable control.

5. The method of claim 3, wherein the selectable control selected to display the at least one child entry comprises a first selectable control, further comprising:
receiving selection of a second selectable control for one entry in the table whose at least one child entry is displayed; and
removing the display of the at least one child entry in the table for the entry associated with the selected second selectable control.

6. The method of claim 1, wherein the table displayed for the selected object includes a first column having a category descriptor and a second column having a description of the category descriptor.

7. The method of claim 1, further comprising:
receiving user selection to add an entry to the displayed table for the selected object at an entry hierarchical relationship with respect to the entries in the table; and
updating the table to include the added entry and to indicate the entry hierarchical relationship of the added entry with the entries in the table.

8. The method of claim 1, further comprising:
receiving user selection to delete or modify an entry in the displayed table for the selected object; and
updating the table to indicate the deletion or modification of the entry selected by the user.

9. The method of claim 1, wherein at least one additional object is associated with at least one additional table, further comprising:
receiving selection of one additional object; and
displaying the additional table associated with the selected additional object.

10. The method of claim 1, wherein the objects are a member of the set of objects comprising: files in a file system, objects, file folders, XML files, and attributes or classifications that may be assigned to an object.

11. A system, comprising:
a processor;
an output device in communication with the processor;
a memory indicating a hierarchical arrangement of objects and a table associated with one object;
a computer readable medium including code executed by the processor to cause operations to be performed, the operations comprising:
(i) displaying at the output device a representation of the hierarchical arrangement of objects;
(ii) receiving selection of one object in the displayed hierarchical arrangement;
(iii) determining whether the table is associated with the selected object; and
(iv) displaying the table associated with the selected object in response to determining that the table is associated with the selected object.

12. The system of claim 11, wherein the operations further comprise:
displaying, in the table, entries arranged in an entry hierarchical relationship to provide information on the object associated with the table.

13. The system of claim 12, wherein the operations further comprise:
displaying selectable controls associated with the entries in the displayed table;
receiving selection of one selectable control associated with one entry; and
displaying at least one child entry for the entry associated with the selected selectable control.

14. The system of claim 13, wherein displaying the at least one child entry comprises displaying child entries as hierarchical children to the entry associated with the selected selectable control.

15. The system of claim 13, wherein the selectable control selected to cause the display of the at least one child entry comprises a first selectable control, wherein the operations further comprise:
receiving selection of a second selectable control for one entry in the table whose at least one child entry is displayed; and
removing the display of the at least one child entry in the table for the entry associated with the selected second selectable control.

16. The system of claim 11, wherein the table displayed for the selected object includes a first column having a category descriptor and a second column having a description of the category descriptor.

17. The system of claim 11, wherein the operations further comprise:
receiving user selection to add an entry to the displayed table for the selected object at an entry hierarchical relationship with respect to the entries in the table; and
updating the table to include the added entry and to indicate the entry hierarchical relationship of the added entry with the entries in the table.

18. The system of claim 11, wherein the operations further comprise:
receiving user selection to delete or modify an entry in the displayed table for the selected object; and
updating the information for the table to indicate the deletion or modification of the entry selected by the user.

19. The system of claim 11, wherein at least one additional object is associated with at least one additional table, wherein the operations further comprise:
receiving selection of one additional object; and
displaying the additional table associated with the selected additional object.

20. The system of claim 11, wherein the objects are a member of the set of objects comprising: files in a file system, objects, file folders, XML files, and attributes or classifications that may be assigned to an object.

21. An article of manufacture including code capable of causing operations to be performed, the operations comprising:
displaying a representation of a hierarchical arrangement of a plurality of objects;
receiving selection of one object in the displayed hierarchical arrangement;
determining whether a table is associated with the selected object; and
displaying the table associated with the selected object in response to determining that the table is associated with the selected object.

22. The article of manufacture of claim 21, wherein the operations further comprise:
displaying, in the table, entries arranged in an entry hierarchical relationship to provide information on the object associated with the table.

23. The article of manufacture of claim 22, wherein the operations further comprise:
displaying selectable controls associated with the entries in the displayed table;
receiving selection of one selectable control associated with one entry; and
displaying at least one child entry for the entry associated with the selected selectable control.

24. The article of manufacture of claim 23, wherein displaying the at least one child entry comprises displaying child entries as hierarchical children to the entry associated with the selected selectable control.

25. The article of manufacture of claim 22, wherein the selectable control to cause the display of the child entries comprises a first selectable control, wherein the operations further comprise:
receiving selection of a second selectable control for one entry in the table whose at least one child entry is displayed; and
removing the display of the at least one child entry in the table for the entry associated with the selected second selectable control.

26. The article of manufacture of claim 21, wherein the table displayed for the selected object includes a first column having a category descriptor and a second column having a description of the category descriptor.

27. The article of manufacture of claim 21, wherein the operations further comprise:
receiving user selection to add an entry to the displayed table for the selected object at an entry hierarchical relationship with respect to the entries in the table; and
updating the table to include the added entry and to indicate the entry hierarchical relationship of the added entry with the entries in the table.

28. The article of manufacture of claim 21, wherein the operations further comprise:
receiving user selection to delete or modify an entry in the displayed table for the selected object; and
updating the table to indicate the deletion or modification of the entry selected by the user.

29. The article of manufacture of claim 21, wherein at least one additional object is associated with at least one additional table, wherein the operations further comprise:
receiving selection of one additional object; and
displaying the additional table associated with the selected additional object.

30. The article of manufacture of claim 21, wherein the objects are a member of the set of objects comprising: files in a file system, objects, file folders, XML files, and attributes or classifications that may be assigned to an object.
